(19) United States
(12) Patent Application Publication
(10) Pub. No.: US 2016/0247243 A1
(43) Pub. Date: Aug. 25, 2016

(54) SYSTEM FOR MEASURING, ANALYZING, ALLOCATING AND PROVISIONING AVAILABLE ELECTRICAL CAPACITY IN A DATA CENTER VISA VIE A SALES ORDER REQUEST TO USE ELECTRICAL CAPACITY

(71) Applicant: EdgeConneX, Inc., Herndon, VA (US)

(72) Inventor: Lance B. Devin, Vienna, VA (US)

(73) Assignee: EdgeConneX, Inc., Herndon, VA (US)

(21) Appl. No.: 15/143,151

(22) Filed: Apr. 29, 2016

(51) Int. Cl. G06Q 50/06; G05F 1/66; G05B 15/02

(52) U.S. Cl. CPC G06Q 50/06; G05B 15/02; G05F 1/66

(57) ABSTRACT

A system for measuring, analyzing, allocating and provisioning a data center's available and usable electrical capacity for new sales order requests that require additional electrical capacity.

This application is based on provisional application Ser. No. 62/284,182 filed Sep. 23, 2015.

### FEDERALLY SPONSORED RESEARCH STATEMENT

Not applicable

### REFERENCE TO SEQUENCE LISTING, A TABLE OR A COMPUTER PROGRAM LISTING

Not applicable

### BACKGROUND OF THE INVENTION

1. Field of the Invention

Data centers have a designed maximum amount of electrical power that it can make available to subsystems in the data center. The subsystems in the data center are typically comprised of computer server equipment (“Servers”), air conditioning equipment like Computer Room Air Handlers (“CRAH”) and Computer Room Air Conditioners (“CRAC”) collectively referred to as “Mechanicals”, electrical supply equipment (“Electricals”), measuring systems and devices (“BMS), lighting and other various subsystems. Power available to the data center is purchased from the electric utility company in a defined maximum quantity. Emergency power systems are designed to provide a matching amount of power should the utility power be disrupted.

Power is then typically distributed in the data center through multiple paths to the computer server equipment, with the principle being that if a single path should fail, an alternative path will most likely not fail at the same time and power can be continuously provided to the computer server equipment. This is typically referred to as dual path distribution. The flow of electricity from Utility Power to Customer Server Equipment is referred to as the Electrical One-Line. An example Electrical One-Line is shown in FIG. 1 and is comprised of:
Automatic Transfer Switch (“ATS”): Determines if the power from the utility is available, and if not automatically transfers the power source to emergency power.
Emergency Power: Typically these are generators, but can be any piece of equipment that can be used to supply an alternate energy source.
Uninterruptable Power Supply (UPS): A set of batteries used to directly feed the customer computer server equipment. It is always charged and recharged from the Emergency power or the Utility Power as determined by the ATS.
Power Distribution Units (PDU): a device fitted with multiple outputs designed to distribute electric power, especially to racks of computers and networking equipment located within the data center.
Remote Power Panel (RPP): a panel board and circuit breaker system which is used as a further means of distributing power fed from the PDU. Each RPP has a defined amount of maximum power distribution and circuit breaker positions.
“WHIP”: a locking power cord that gets power from an RPP and delivers that power to a cabinet receptacle bank. Each whip is power rated for maximum capacity.
Cabinet PDU (iPDU): a receptacle bank in a cabinet that customer computer server equipment is plugged into that gets its power from a WHIP.

Allocating Power that will be required by the Servers in a cabinet, must take into consideration and must not exceed the capacities and thresholds of each of the electrical one-line pieces of equipment. Load balancing across dual paths, and electrical phases must also be accounted for when designing power allocation in the data center.

Additionally, servers that by definition create heat from power consumed, must be appropriately cooled to maintain proper operations. A set of mechanicals also have capacities that are based on air flow and British Thermal Units (BTUs), and a host of other attributes. Mechanicals capacities must also be taken into consideration with respect to allocating power to the Servers.

The distance of a Server to an RPP will impact the cost of installation and material, and that can be analyzed for appropriate capacity management.

Further, power draws from Server Equipment can be and need to be measured as to
Name Plate: Manufacture recommended maximum electric power draw,
Average: The average amount of power consumed during normal operations over a defined period of time,
Peak: The actual peak power consumed by Server equipment,
Allocated: the amount of power defined by the circuit breaker assigned to the Server Equipment,
   in order to get an accurate picture of existing power requirements in the data center as it will pertain to future requirements of new Server equipment.

Furthermore, a data center is designed to reach a maximum capacity, “Designed Capacity”. The power capacity of a functional, but partially completed data center is referred to as “As Built Capacity”.

### BRIEF SUMMARY OF THE INVENTION

It is the objective of the inventive system to analyze a request for power in a data center (“Order”) as it relates to the capacities of all the components comprising the subsystems (“Electricals” and “Mechanicals”). The analysis of the power request takes into consideration the different measurements of actual power consumption as read from a Building Management System (Peak, Average, and Allocated), as it relates to maximum sub-system capacities as they were installed (As Built Capacity), and as they are designed to be (Designed Capacity).

The inventive system applies an Order to the data center as an accrual or as a debit against total power. An accrual will subtract the Order from the remaining data center As Built and Designed Capacities but indicates that the Order has not been provisioned into the data center. Provisioning is the process of actually installing the Order into cabinets and RPPs. Accrued power can easily be returned to the remaining power total as it does not represent a physical manifestation/installation of the order, only a logical one. An order that is debited, indicates that the power is subtracted from the remaining data center Designed Capacity and As Built capacities both logically and physically through the provisioning process.

Furthermore, the inventive system automates the order provisioning process by importing the order from a sales ordering system, suggesting all the proper circuit breaker positions (“Poles”), in the appropriate RPPs, updating a database system that maintains the information about all RPPs and their Poles, and lastly creating a Work Order in a computerized maintenance system for the work management of the physical installation into the data center.

### DETAILED EXPLANATION OF INVENTION

### Definitions and Explanation of Terms Specific to the Disclosure

### DESCRIPTION OF THE FIGURE

FIG. 1 is an example representation of an electrical system in a data center, referred to as a One-Line.

FIG. 2 is an interaction model of systems, subsystems and ancillary systems, and information of the preferred embodiment of the invention.

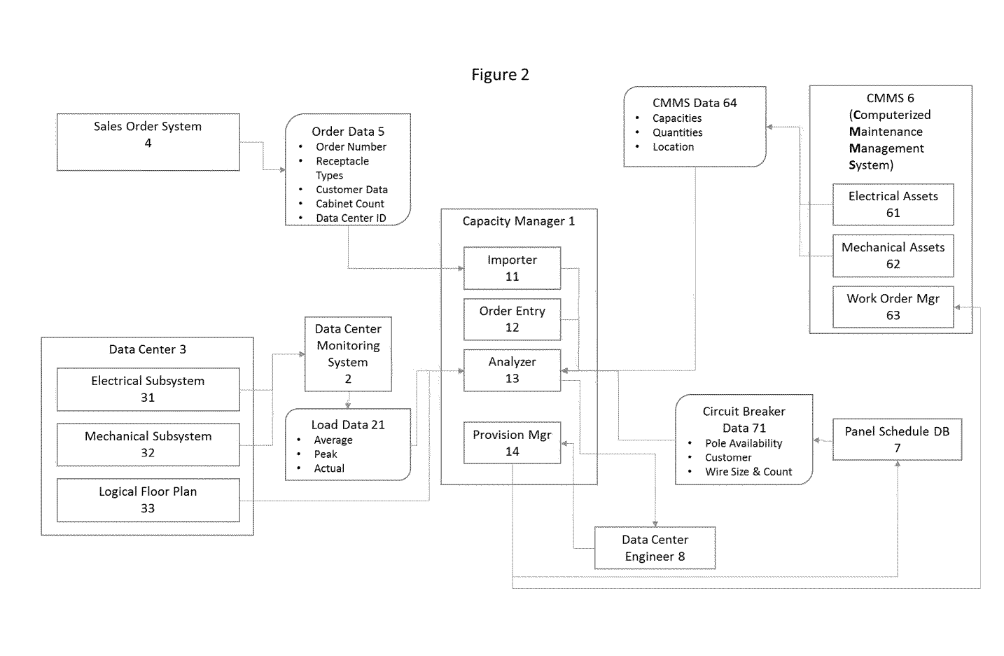

Referring to FIG. 2, the following components are described.

Capacity Manager 1 is a bespoke application programmed in commercially available programming language consisting of Importer 11, Order Entry 12, Analyzer 13, and Provision Manager 14. It represents the analytics and processes of the invention and is described in detail herein. It's purpose is to measure, analyze and allocate available electrical capacity in a data center requested in Sales Order System 4 to utilize electrical capacity.

Importer 11: A bespoke sub component programmed in commercially available programming language, responsible for extracting Order Data 5 from Sales Order System 4, into the Capacity Manager 1. As described in detail below, Importer 11 transforms the data for use by Analyzer 13. The transformation is a process that changes representation of data in one system to the representation of another systems.

Order Entry 12: A bespoke sub-component programmed in commercially available programming language, responsible for allowing manual entry of Order Data 5 into Capacity Manager 1. Order Entry 12 provides the data for use by Analyzer 13.

Analyzer 13: A bespoke sub-component programmed in a commercially available programming language, responsible for comparing Order Data 5 to the Designed and As Built Capacities of a specific data center, so as to determine if the power in the data center is adequate to be allocated to the Order in the provisioning process.

Provision Manager 14: A bespoke sub-component programmed in a commercially available programming language, that assigns an Order's power requirement to a specific RPP in Panel Schedule DB 7, and creates a work-to-be-performed-order in Work Order Mgr 63. Data Center Monitoring System 2: A commercially available or bespoke SCADA system (often referred to as Data Center Information Management system [DCIM] used for the purpose of 138 gathering real-time data related to Data Center 3 subsystems and operations.

Load Data 21: The subset of information (as explained above and in FIG. 2) gathered by Data Center Monitoring System 2 that is required by Capacity Manager 1 in order to provision Order Data 5 into a specific Data Center 3.

Data Center 3: A building and systems designed for the purpose of running Servers without interruption. Systems that maintain the operations of Servers include Dual Pathway electrical subsystem 31, Mechanical Subsystem 32 maintaining appropriate humidity and cooling, Logical Floor Plan 33 for the location of cabinets that house Servers.

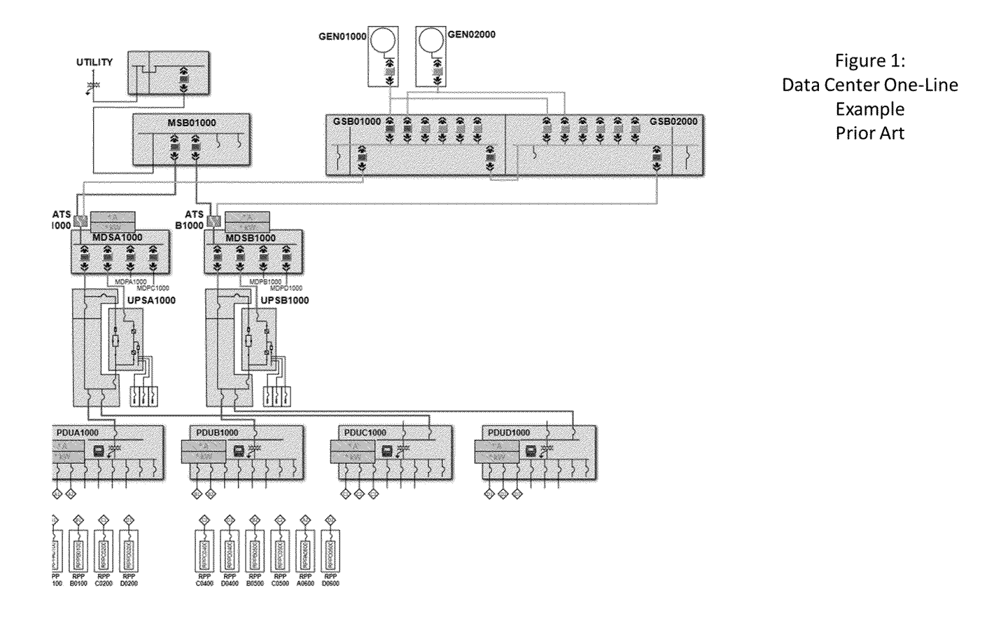

Electrical Subsystem 31: Equipment used to continuously and without interruption provide power to Servers. Electrical subsystems vary by design of Data Center 3, but often include: Utility Power, ATSs, Manual Transfer Switches (“MTS”), UPSs, PDUs, RPPs, WHIPS, and iPDUs. Each component has associated power maximum capacities. This is represented as an example in FIG. 1.

Mechanical Subsystem 32: Equipment used to provide temperature and humidity control for optimal running of Servers. Mechanical equipment have the capability to cool and dehumidify a defined quantity of power (which in turn gives off heat). The capacity of environment equipment is measured in kilowatts (kW).

Logical Floor Plan 33: A bespoke database system indicating rows of cabinets housing Servers, the number of cabinets per row and the number of row capacity in a data center and position of cabinets. Logical Floor Plan 33 provides a distance relationship between RPP (last electrical system) and Server that affects costs and capability.

Sales Order System 4: A commercially available and customizable sales system that is used to enter Order Data 5, and track the sales status of orders for Data Center 3 power by customer and by data center.

Order Data 5: Sales order data that is relevant to Capacity Manager 1. It is comprised of the order number for tracking purposes, Receptacle types for defined power needs, data center id, and customer data.

CMMS 6: Computerized Maintenance Management System is a proprietary version of commercially available software. The CMMS system is responsible for storing information with regards to assets. It manages work to be done within the Data Center as it pertains to those assets. Typical work defined in the system includes maintenance on asset equipment and customer requests for power. It is important that users understand these processes so they can better understand the data being presented to them in the CMMS.

Electrical Assets 61: An inventory of electrical assets installed in Data Center 3, stored in CMMS 6. Assets can have a multitude of pre-defined and user-defined attributes. Attributes important for the invention include CMMS Data 64 described below.

Mechanical Assets 62: An inventory of mechanical assets installed in Data Center 3 and stored in CMMS 6. Assets can have a multitude of pre-defined and user-defined attributes. Attributes important for the invention include CMMS Data 64 described below.

Work Order Manager 63: Subsystem of CMMS 6 that tracks actual work performed and completed against Electrical Assets 61 and Mechanical Assets 62 by Data Center Engineer 8 and other data center operational personnel.

CMMS Data 64: A set of attributes stored in CMMS 6 pertaining to Electrical Assets 61 and Mechanical Assets 62, pertinent to Analyzer 13 for the purpose of the invention Capacity Manager 1.

Panel Schedule DB 7: A bespoke set of tables in a commercially available database system, used for the tracking of circuit breaker positions and availability. Panel Schedule DB 7 is used in the Data Center Monitoring System 2 to understand individual customer power consumption and existing actual power allocations.

Circuit Breaker Data 71: The set of circuit breaker information stored in Panel Schedule DB 7 that is used by Capacity manager 1, Analyzer 13, and is stored by Provision Mgr 14.

In the preferred embodiment, Capacity Manager 1 maintains a database of Data Center 3 information that includes Designed Capacity, As Built Capacity and Available Capacities. As stated previously, the Designed Capacity represents the maximum capacity of the data center as it is designed to be. The Designed Capacity has internal consistency between the capacities required for power and generated heat, Electrical Assets 61, and cooling, Mechanical Assets 62. This means that the total capacity of the data center can be served by all the subsystems in the data center. The Designed Capacity number is non-variable and entered as static data.

The construction of a data center can be done in different phases, leaving some of the designed equipment out. This does not impact the operations from the data center except for lowering the total capacity that is available to Servers at that time, the As Built Capacity. The As Built Capacity is derived from the equipment inventories stored in CMMS 6 using CMMS Data 64.

The Designed Capacity and the As Built Capacity are one in the same for a 100% completely built data center. The importance of the Designed Capacity is that the data center operator can easily sell and create orders against it. The implementation of Order Data 5, has to be considered solely in relation to the As Built Capacity. Order Data 5 that exceeds the Design Capacity can never be implemented into the data center.

Capacity Manager 1 also maintains information about Logical Floor Plan 33 as part of the Data Center 3 information. In the preferred embodiment, this information contains the location of cabinets in Data Center 3, location of RPPs in the data center. This information will be used by Analyzer 13 identify the closest RPPs that have capacity to fulfill the Order. Further details are described below.

ORDER ENTRY: Data Center Engineer 8 uses Capacity Manager 1 to either import Order Data 5 into Capacity Manager 1 using Importer 11, or directly enters Order Data 5 into Capacity Manager 1, using Order Entry 12. In either case the Order Data 5 contains Order Number, Receptacle Types, Customer Data, Cabinet Counts and Data Center ID. In combination, Order Data 5 contains information to specify an individualized circuit power requirement, a summated set of requirements for power by cabinet, and a summated set of requirements for power for the entire order. Capacity Manager 1 stores the transformed Order Data 5 in its own database for further processing. Transformed information includes the receptacle type from a list of standard receptacles defined by organizations like NEMA, the redundancy of the circuit, and the location of the cabinet on the floor in a grid system. Based on the receptacle types, the system will automatically fill out required information including poles, amps, wire count and wire size from lookup tables. Cabinets and allocations are internally checked for referential consistency and errors by Importer 11. If entered manually or the Order Entry 12 performs similar checks for duplications, typographic errors, information consistency, and other obvious errors.

Capacity Manager 1 maintains a history of all Order Data 5 for all Data Centers 3. The list can be reviewed by Data Center Engineer 8 to review, check, or provision orders at a time of their choosing. The inventive system allows for filtering and searching Order Data 5 based on criteria that can include but not limited to: data center ID, date, and status.

When Order Data 5 is entered into the system, the power request is automatically broken down by cabinet and further broken down by receptacle. Capacity Manager 1 presents the order in a hierarchy from the top node being the order number, the child nodest being the cabinets for the order, and the child node to the cabinets being the receptacles for that cabinet. Each receptacle is assigned a request number representing a partial order. Each request number may be individually analyzed and or provisioned within Analyzer 13 and Provision Mgr 14. Capacity Manager 1 creates an engineering sheet that provides specific information to Data Center Engineer 8 about the proposed RPP and the status of the RPPs before the order is processed and after the order is processed by Analyzer 13.

ORDER ANALYSIS: Data Center Engineer 8 uses Analyzer 13 of Capacity Manager 1 to check data center available power with respect to Order Data 5 power requirements. Checking involves analyzing Order Data 5 power requirements against the As Built Capacity and the Designed Capacity. Analyzer 13 requests Circuit Breaker Data 71 from Panel Schedule DB 7 and Load Data 21 from Data Center Monitoring System 2 to set up the comparison criteria. If Analyzer 13 determines that the Order Data 5 can be fulfilled from the available power in Data Center 3, Data Center Engineer 8 can use Capacity Manager 1 to Accrue or Debit the power requirements of the order against both the As Built Capacity and the Designed Capacity. Accruing the power requirements means that a logical reserve is held against the As Built and Designed Capacities, but the physical implementation has not been started nor completed. Debiting the power requirements of Order Data 5, means that the power will be implemented Data Center 3 and the power requirement is permanently subtracted from total Designed and As Built Capacities. Whether the power requirements of Order Data 5 have been accrued or debited, the remaining available power in the data center is maintained accurately so that new sales orders can be accurately checked against available power capacities.

As described in detail below Capacity Manager 1 calculates available capacity by subtracting Accrued and Debited order power requirements from the As Built and Design Capacities for Data Center 3.

PROVISIONING AN ORDER: Data Center Engineer 8 provisions Order Data 5 into Data Center 3. Analyzer 13 retrieves Circuit Breaker Data 71 from Panel Schedule DB 7 in order to determine the set of available pole positions on the RPP. Analyzer 13 also retrieves Load Data 21 from Data Center Monitoring System 2 to determine the usage patterns and capacity availability on Electrical Assets 61 and Mechanical Assets 62. With Logical Floor Plan 33 data used to measure distances, Analyzer 13 can determine through an algorithm using the capacities of the Electrical Assets 62 in the One-Line, the possible installation of Order Data 5 as it pertains to Pole Positions and RPPs. The best available option will be the RPP and Pole positions that are electrically phase balanced, physically closest to the cabinet location, has available electrical capacity and can be cooled by Mechanical Assets 62 most efficiently and within capacity. Analyzer 13 presents Data Center Engineer 8 with the choice to automatically or manually choose the RPPs and Pole positions for Order Data 5. Manual intervention allows Data Center Engineer 8 to over-ride the Analyzer 13 algorithm in the event there are more than one possible choice and the best available choice isn't preferred. Automated assignment will take the best available option. Data Center Engineer 8 is asked to confirm the choices of RPP and Pole Position.

Provision Mgr 14 takes Data Center Engineer 8 decisions and automatically updates Panel Schedule DB 7 with the RPP and Pole Positions chosen. Panel Schedule DB 7 information is critical to the operations of Data Center Monitoring System 2 in the function it performs unrelated to the inventive system (e.g. customer power usage and billing, circuit protection monitoring, etc.). Provision Mgr 14 also automatically creates Work Order Mgr 63 in CMMS 6 to schedule the work for physical installation. The resulting work order contains Order Data 5 and Circuit Breaker Data 71 for completeness and accuracy. Provision Mgr 14 will take a provisioned order and automatically debit Designed Load and the As Built Loads accordingly if it hasn't been done already.

Information about the site and the subsystems are presented as guides throughout the selection process to provide feedback to the user during the provisioning process. The information can include: A listing of the available Pole Positions on each RPP, the power capacities as percent of actual and provisioned power, kW (kilowatts) capacities, quantities, and more.
While the invention has been particularly shown and described in conjunction with a preferred embodiment thereof, it will be appreciated that variations and modifications will occur to those skilled in the art. Therefore, it is to be understood that the claims are intended to cover all such modifications and changes as fall within the true spirit of the invention.

1. In a computer-based electrical capacity management system, a method of accruing a customer order for electrical capacity, comprising one or more circuit breaker definitions, against the remaining designed and remaining as-built electrical capacities of said data center including the steps of:
creating said order that includes the amperage and redundancy of the requested circuit breakers(s);
analyzing each said circuit breaker defined in said order for amperage and redundancy against said remaining as-built capacity of said data center and determining if said order can be fulfilled;
analyzing each said circuit defined in said order for amperage and redundancy against said remaining designed capacity of said data center and determining if said order can be fulfilled;
prompting a user of said system, to the status of said order or individual parts of said order that can be fulfilled, so that said user may determine that said order or parts thereof are to be accrued;
accruing the electrical capacities of said order by subtracting said order electrical capacities from said remaining designed and said remaining as-built capacities in said data center;
preventing further electrical capacity orders from being provisioned or reserved because they have exceeded said remaining as-built less the reserved said order, and said remaining designed capacities less the reserved said order, unless manually overridden by said user of said system.

2. The method of claim 1 whereby the step of creating said order in the computer-based capacity management system may be achieved by importing said order from a separate order collection system.

3. In a user-controlled computer-based electrical capacity management system, a method of determining the additional equipment that is needed in a data center to address a customer order comprising one or more circuit breaker definitions, by analyzing the electrical capacity requested visa vie the remaining designed, and remaining as-built capacities of the data center including the steps of:
creating said order in the system that defines the amperage and redundancy of the requested circuit breaker(s);
determining said data center's as-built and as-designed equipment and their maximum capacities;
analyzing each circuit breaker defined in said order for amperage and redundancy against said remaining as-built capacities across each type of said electrical equipment in said one-line;
analyzing each circuit defined in said order for amperage and redundancy against said remaining as-designed capacities across each type of said electrical equipment in said one-line;
analyzing each circuit defined in said order for amperage and heat generation against said remaining as-built capacities of each piece of said cooling/mechanical equipment in said one-line;
determining for each type of said electrical equipment in said one-line or cooling equipment if the order will require a new piece of equipment of that specific type that falls within the as-built and as-designed maximal capacities of said data center;
alerting said user of said system, that specific quantities of a specific type of equipment needs to be ordered to fulfill said order.

4. The method of claim 3 whereby the step of creating said order in the computer-based capacity management system may be achieved by importing said order from a separate order collection system.

5. In a user-controlled computer-based electrical capacity management system, a method of determining all capacity-available circuit breaker locations in RPPs in a data center taking into consideration the remaining designed, remaining as-built, and as-used electrical and mechanical capacities of said data center; and the location of customer equipment in said data center requiring electrical capacity as defined in a customer order comprising one or more circuit breaker definitions, including the steps of:
creating said order in said system that defines the amperage and redundancy of the requested circuit breaker(s);
allocating said customer equipment into available said data center floor space to assist in determining the distance to available said circuit breaker locations in said RPP(s);
determining that there is available electrical capacities in all system types found in said data center equipment;
determining available and used circuit breaker locations in said data center, and the distances of said circuit breaker locations to all possible data center floor locations;
refining the list of available said circuit breaker locations based on capacity-availability of said circuit breakers(s) that meet the requirements of said order;
refining the list of capacity-available circuit breakers based on cooling capacities of said data center equipment with respect to customer equipment locations;
refining the list of said electrically capable and cooling capable circuits based on distance;
providing said user with the resulting, refined-list of circuit breaker locations;
allowing user of said system to choose said circuit breaker location of said order.

6. The method of claim 5 whereby the step of creating said order in the computer-based capacity management system may be achieved by importing said order from a separate order collection system.

7. The method of claim 5 of listing the resulting, refined-list of circuit breaker locations, in descending order of preference based on electrical capacity, cooling capacity, and distance.

8. The method of claim 5 whereby the best available circuit location is automatically chosen from the list of available and suitable circuit locations where best is defined as closest to said customer equipment, with the capability of being adequately cooled because there is available cooling capacity, and the electrical capacity is greater than said circuit in said order, and there is balanced phasing of electrical current across all systems.

9. In a user-controlled computer-based electrical capacity management system, a method of automatically choosing the most efficient capacity-available circuit breaker location in an RPP in a data center taking into consideration the remaining designed, remaining as-built, and as-used electrical and mechanical capacities of said data center; and the location of customer equipment in said data center requiring electrical capacity as defined in a customer order comprising one or more circuit breaker definitions, including the steps of:
creating said order in said system that defines the amperage and redundancy of the requested circuit breaker(s);
allocating said customer equipment into available said data center floor space to assist in determining the distance to available said circuit breaker locations in said RPP(s);
determining that there is available electrical capacities in all system types found in said data center equipment;
determining available and used circuit breaker locations in said data center, and the distances of said circuit breaker locations to all possible data center floor locations;
refining the list of available said circuit breaker locations based on capacity-availability of said circuit breakers(s) that meet the requirements of said order;
refining the list of capacity-available circuit breakers based on cooling capacities of said data center equipment with respect to customer equipment locations;
refining the list of said electrically capable and cooling capable circuits based on distance;
refining the list based on the shortest distance;
provisioning the said preferred available circuit breaker location.

10. A method of claim 5 whereby said selected circuit location(s) and said customer order information are combined into an automatically created electronic work order for a computerized maintenance management system and identifies said selected circuit breaker locations as unavailable for future use.

11. A method of claim 9 whereby said selected circuit location(s) and said customer order information are combined into an automatically created electronic work order for a computerized maintenance management system and identifies said selected circuit breaker locations as unavailable for future use.
